(19) United States
(12) Patent Application Publication
(10) Pub. No.: US 2005/0265643 A1
(43) Pub. Date: Dec. 1, 2005

(54) Electrical machine

(76) Inventors: Antonio Diaz Alsina, Laredo (ES); Manuel Diaz Garcia, Liencres (ES); Pedro Sanchez Carrasco, Madrid (ES)

Correspondence Address: Striker Striker & Stenby, 103 East Neck Road, Huntington, NY, 11743, US

(21) Appl. No.: 10/508,632

(22) PCT Filed: Dec. 17, 2002
(86) PCT No.: PCT/DE02/04605

§ 371 Date: Jul. 18, 2005

(30) Foreign Application Priority Data
Mar. 19, 2002 (DE) 10212074.9

(51) Int. Cl. F16C 33/04

(52) U.S. Cl. 384/493

(57) ABSTRACT

An electrical machine, in particular an alternator, is provided that has a shaft (13) that is held in at least one movable bearing point (25) by at least one bearing (19) in a hub (22). A metal sliding element (28) is fixed on the hub side between the bearing (19) and the hub (22).

### BACKGROUND INFORMATION

An electrical machine is made known in DE 89 11 295 4 U1, in which a shaft is supported in a hub of a housing by a movable bearing. A sliding element is fixed on the hub side between the bearing and the hub. The sliding element permits the bearing to slide in the hub when the shaft undergoes thermally-induced changes in length and compensates for temperature fluctuations and, therefore, changes in play in the hub. The disadvantage of this prior art is that the sliding ring or sliding element made of plastic is inadequately resistant to operation-induced stress on the movable bearing, so the play of the bearing inadvertently increases, and increases even further due to magnetic forces. The stress on the bearing is therefore increased beyond the tolerable level.

### ADVANTAGES OF THE INVENTION

The electrical machine having the features of the main claim has the advantage that, due to the metallic sliding element, it has high hardness, which greatly limits the wear on the sliding element and also ensures high dimensional stability of the sliding element, the support is particularly reliable and particularly long-lasting. Due to the measures listed in the subclaims, advantageous further developments of the electrical machine according to the main claim are possible. A particularly high dimensional stability results because the sliding element has a minimum hardness of 570 HV 10.

The sliding element is particularly easy to manufacture because it is annular in shape. If a generally tubular sleeve abuts the sliding element that is joined with this sliding element, it is possible to encapsulate the collector-ring space using this sliding element and its tubular sleeve part. Encapsulating the collector-ring space makes it possible to seal out detrimental environmental influences, such as dust, humidity and wetness. According to a further embodiment, it is provided that the sleeve part is joined with the sliding ring using a connecting-element arrangement. This connecting-element arrangement has the advantage that it enables a reliable connection between the sliding ring and the sleeve part. A particularly favorable and reliable connection between the sliding ring and the sleeve part is obtained using a connecting-element arrangement configured with snap-on elements. A further reliable method of connecting the sleeve part with the sliding ring in functionally secure fashion is to integrally extrude the sleeve part, which is made of plastic, on the sliding ring using a plastic pressure-casting method.

Using the features of the coordinated claim, it is possible to provide a sliding ring for installation in the hub of a rotating machine, whereby a tubular sleeve part abuts the metallic sliding element.

### BRIEF DESCRIPTION OF THE DRAWING

An exemplary embodiment of an electrical machine according to the invention and a sliding element according to the invention are shown in the figures.

FIG. 1 is a sectional drawing of a partially abstract embodiment of an electrical machine,

FIG. 2 is a sectional drawing of a sliding element according to the invention.

### DETAILED DESCRIPTION OF THE EMBODIMENTS

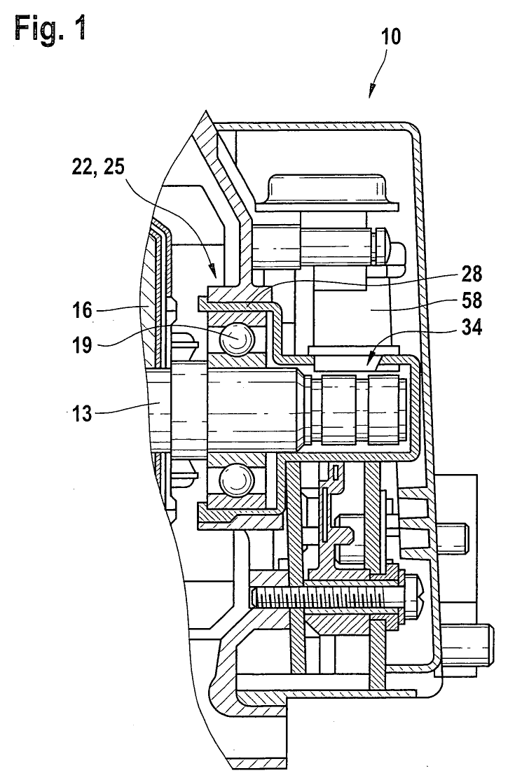

A partial sectional drawing of an electrical machine 10 is shown in FIG. 1. In addition to further parts that are not shown nor essential to the invention, electrical machine 10 has a shaft 13 on which an electrically active rotor 16 is mounted. Shaft 13 is held by at least one bearing 19 in a hub 22 composed of a metal alloy, e.g., an aluminum alloy. The support of shaft 13 of this hub 22 is configured as a “movable bearing point” 25. This movable bearing point 25 permits axial relative movement between bearing 19 mounted on shaft 13 and hub 22. A sliding element 28 is inserted and fixed in the hub between bearing 19 and hub 22, and the sliding element is composed of metal. Sliding element 28 is fixed in hub 22 using a press fit. It is provided that sliding element 28 has a minimum hardness of 570 HV 10. As indicated, the hardness is measured according to the Vickers hardness testing method. Ideally, the hardness is between 570 and 640 HV 10.

In order to maintain an even seat of bearing 19 in hub 22, it is provided that sliding element 28 is configured as a ring.

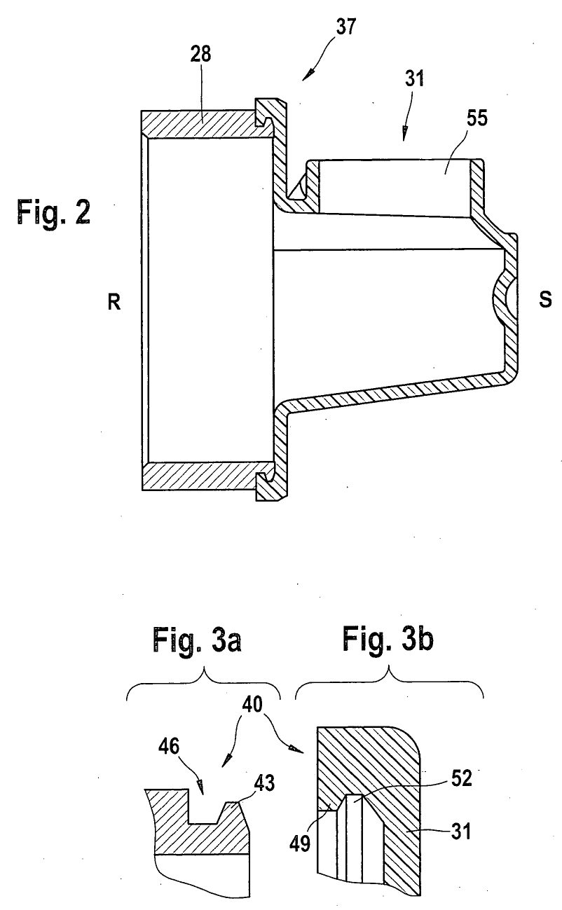

A further exemplary embodiment of sliding element 28 is shown in FIG. 2. First of all, sliding element 28 has the annular shape mentioned previously and has a rotor side R and a collector-ring side S. Sliding element 28 is joined with generally tubular sleeve part 31 that abuts sliding element 28. The purpose of sleeve part 31 in electrical machine 10 is to surround a sliding-contact device 34 and protect it from detrimental environmental influences.

Sleeve part 31 is joined with sliding element 28 by a connecting-element arrangement 37. Connecting-element arrangement 37 includes a snap-on connection shown in FIGS. 3a and 3b, for example, in which sliding element 28 and sleeve part 31 each have snap-on elements 40 that interact with each other. On its collector-ring side, sliding element 28 has an annular bead 43 and, abutting it axially in the direction toward the rotor, an annular groove 46. Accordingly, sleeve part 31 has, on its side closest to the rotor, an annular element 49 that extends radially inwardly and that axially abuts a radially outwardly extending annular groove 52 in the direction toward the collector-ring side. As a result, sleeve part 31 and sliding element 28 are capable of being joined by engaging annular element 49 of sleeve part 31 in annular groove 46 of sliding element 28. Conversely, annular bead 43 engages in annular groove 52 of the sleeve element of sleeve part 31. In a further exemplary embodiment, it is provided that sleeve part 31 is integrally extruded on sliding ring 28.

It is provided that sliding element 28 has positively-interlocking elements, as shown previously in FIG. 3a. These positively-interlocking elements are previously-mentioned annular groove 46 and annular bead 42. By extrusion-coating these two elements, at least partially, a suitable connection between sliding element 28 and sleeve part 31 is obtained.

As shown in FIG. 1, sleeve part 31 at least partially covers sliding-contact device 34 to provide current to rotor 16 and/or electrical machine 10. An opening 55 is provided in the region of sliding-contact device 34 on the periphery of the sleeve part 31, in which a brush holder 58 is insertable.

1. An electrical machine, in particular an alternator, with a shaft (13) that is held in at least one movable bearing point (25) by at least one bearing (19) in a hub (22), whereby a sliding element (28) is fixed on the hub side between the bearing (19) and the hub (22), wherein the sliding element (28) is composed of metal.

2. The electrical machine as recited in claim 1,
wherein the sliding element (28) has a minimum hardness of 570 HV 10.

3. The electrical machine as recited in claim 1
wherein the sliding element (28) is a ring.

4. The electrical machine as recited in claim 1
wherein a generally tubular sleeve part (31) abuts the sliding element (28) and is joined with the sliding element.

5. The electrical machine as recited in claim 4,
wherein the sleeve part is joined with the sliding element (28) by a connecting-element arrangement (37).

6. The electrical machine as recited in claim 5,
wherein the connecting-element arrangement (37) is composed of snap-on elements (40).

7. The electrical machine as recited in claim 4,
wherein the sleeve part (31) is integrally extruded on the sliding element (28).

8. The electrical machine as recited in one claim 4
wherein the sleeve part (31) at least partially covers a sliding-contact device (34), and there is an opening (55) in the region of the sliding-contact device (34), in which a brush holder is insertable.

9. A sliding element for installation in the hub (22) of an electrical machine (10),
wherein the sliding element (28) is metallic.

10. The sliding element as recited in claim 9,
wherein a tubular sleeve part (31) abuts the sliding element (28).
